(19) United States
(12) Patent Application Publication
(10) Pub. No.: US 2026/0323407 A1
(43) Pub. Date: Oct. 15, 2026

(54) BEAM REPORTING FOR A CANDIDATE CELL IN L1 AND L2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/108,415

(22) PCT Filed: Nov. 2, 2022
(86) PCT No.: PCT/CN2022/129140

§ 371 Date: Mar. 3, 2025

(51) Int. Cl. H04W 36/00

(52) U.S. Cl. CPC H04W 36/0058

(57) ABSTRACT

Apparatus, methods, and computer program products for wireless communication are provided. An example method may include receiving, from a second network entity, downlink control information (DCI) indicative of a configuration of inter-frequency reference signal (RS) reporting in a layer 1 (L1) inter-frequency channel state information (CSI) report associated with one or more RSs. The example method may further include generating measurement information based on the one or more RSs. The example method may further include transmitting the LI inter-frequency CSI report, where the LI inter-frequency CSI report is based on the measurement information.

### TECHNICAL FIELD

The present disclosure relates generally to communication systems, and more particularly, to wireless communication systems with layer 1 (L1) and layer 2 (L2) mobility.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a first network entity, such as a user equipment (UE) are provided. The apparatus may include a memory and at least one processor coupled to the memory. The at least one processor may be configured to receive, from a second network entity, downlink control information (DCI) indicative of a configuration of inter-frequency reference signal (RS) reporting in a layer 1 (L1) inter-frequency channel state information (CSI) report associated with one or more RSs. The at least one processor may be configured to generate measurement information based on the one or more RSs. The at least one processor may be configured to transmit the L1 inter-frequency CSI report, where the L1 inter-frequency CSI report is based on the measurement information.

In another aspect of the disclosure, a method, a computer-readable medium, and an apparatus at a first network entity, such as a network node (e.g., a base station) are provided. The apparatus may include a memory and at least one processor coupled to the memory. The at least one processor may be configured to transmit, for a second network entity, DCI indicative of a configuration of inter-frequency RS reporting in a L1 inter-frequency CSI report associated with one or more RSs. The at least one processor may be configured to receive the L1 inter-frequency CSI report, where the L1 inter-frequency CSI report is based on measurement information.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of movement of UE and associated switching of special cell (SpCell) based on a configured candidate SpCell set.

FIG. 5 is a diagram illustrating an example of L1 measurement.

FIG. 6 is a diagram illustrating an example of communications related to L1 inter-frequency CSI report.

FIG. 7 is a diagram illustrating example communications between a network entity and a UE.

FIG. 8 is a flowchart of a method of wireless communication.

FIG. 9 is a flowchart of a method of wireless communication.

FIG. 10 is a diagram illustrating an example of a hardware implementation for an example apparatus and/or network entity.

FIG. 11 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

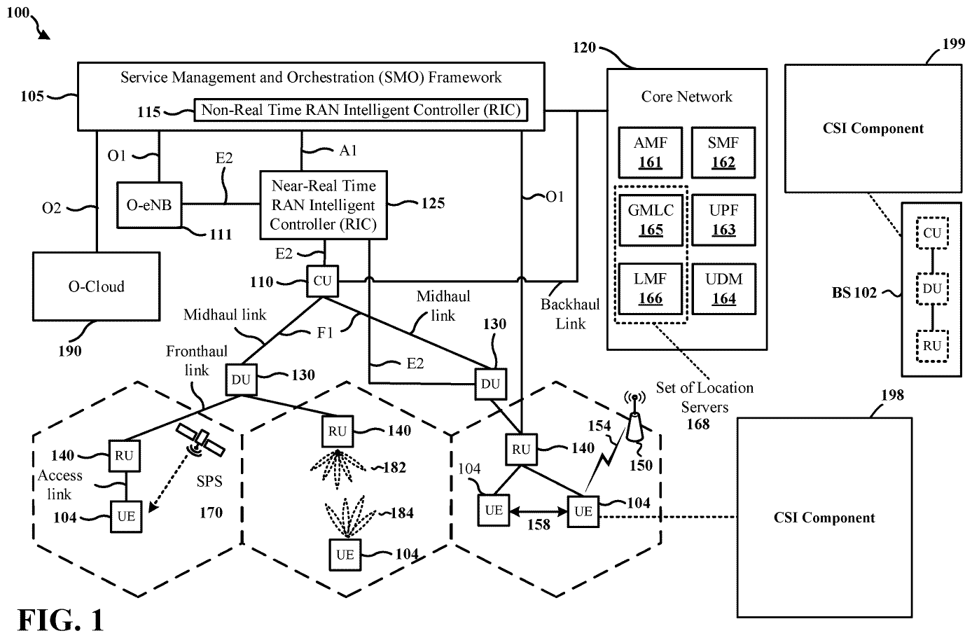

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RTRIC 125. The Near-RTRIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RTRIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHZ-52.6 GHz). Although a portion of FR1 is greater than 6 GHz, FR1 is often referred to (interchangeably) as a “sub-6 GHZ” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHZ” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU.

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a CSI component 198. In some aspects, the CSI component 198 may be configured to receive, from a second network entity, DCI indicative of a configuration of inter-frequency RS reporting in a L1 inter-frequency CSI report associated with one or more RSs. In some aspects, the CSI component 198 may be configured to generate measurement information based on the one or more RSs. In some aspects, the CSI component 198 may be configured to transmit the L1 inter-frequency CSI report, where the L1 inter-frequency CSI report is based on the measurement information.

In certain aspects, the base station 102 may include a CSI component 199. In some aspects, the CSI component 199 may be configured to transmit, for a second network entity, DCI indicative of a configuration of inter-frequency RS reporting in a L1 inter-frequency CSI report associated with one or more RSs. In some aspects, the CSI component 199 may be configured to receive the L1 inter-frequency CSI report, where the L1 inter-frequency CSI report is based on measurement information.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

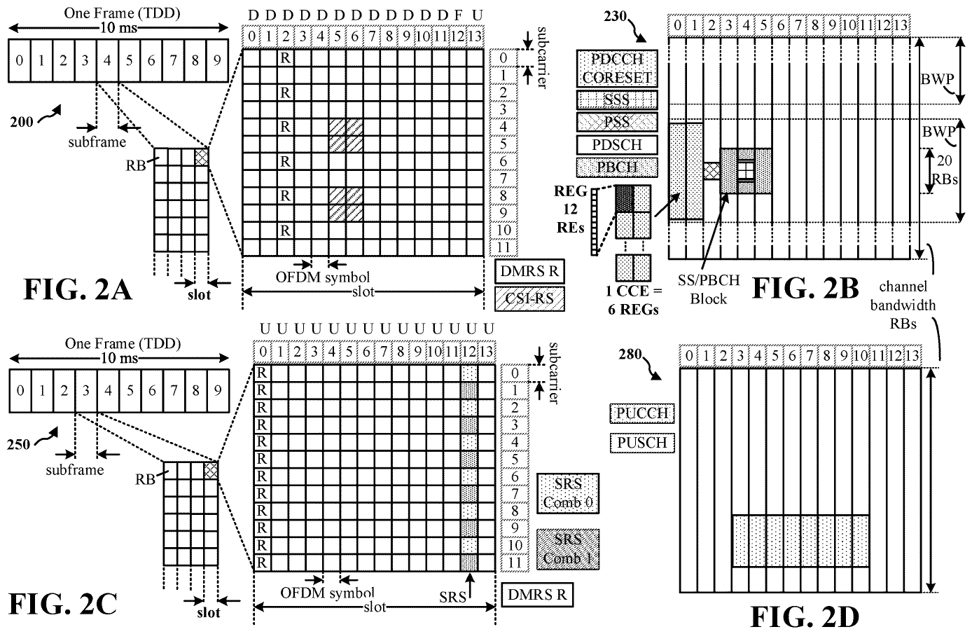

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI).

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

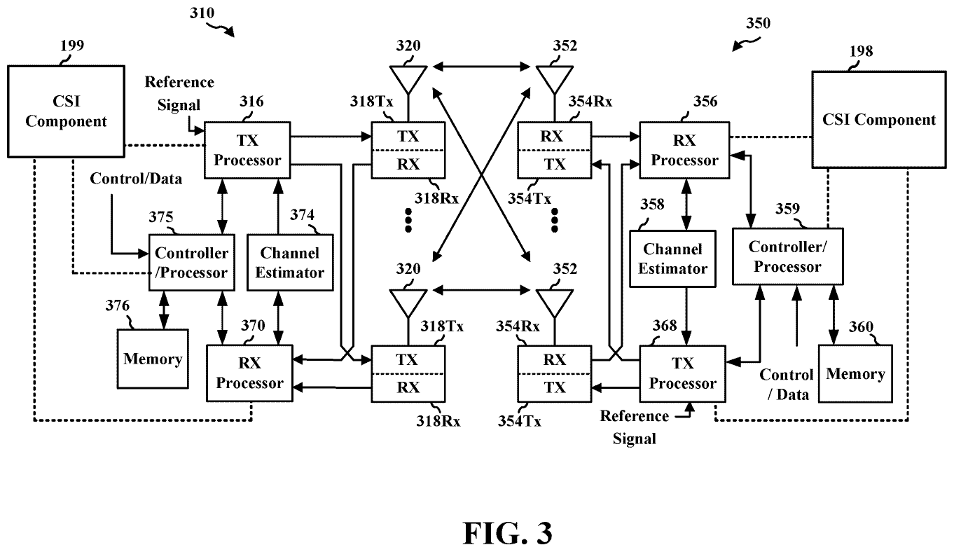

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with CSI component 198 of FIG. 1.

At least one of the TX processor 316, the RX processor 370, and the controller/processor 375 may be configured to perform aspects in connection with CSI component 199 of FIG. 1.

In response to different conditions, beams may be switched. For example, a transmission configuration indication (TCI) state change may be transmitted by a base station so that the UE may switch to a new beam for the TCI state. The TCI state change may cause the UE to find the best UE receive beam corresponding to the TCI state from the base station, and switch to such beam. Switching beams may allow for enhanced or improved connection between the UE and the base station by ensuring that the transmitter and receiver use the same configured set of beams for communication.

A TCI state may include quasi-co-location (QCL) information that the UE can use to derive timing/frequency error and/or transmission/reception spatial filtering for transmitting/receiving a signal. Two antenna ports are said to be quasi co-located if properties of the channel over which a symbol on one antenna port is conveyed can be inferred from the channel over which a symbol on the other antenna port is conveyed. The base station may indicate a TCI state to the UE as a transmission configuration that indicates QCL relationships between one signal (e.g., a reference signal) and the signal to be transmitted/received. For example, a TCI state may indicate a QCL relationship between DL RSs in one RS set and PDSCH/PDCCHDM-RS ports. TCI states can provide information about different beam selections for the UE to use for transmitting/receiving various signals. Under a unified TCI framework, different types of common TCI states may be indicated. For example, a type 1 TCI may be a joint DL/UL common TCI state to indicate a common beam for at least one DL channel or RS and at least one UL channel or RS. A type 2 TCI may be a separate DL (e.g., separate from UL) common TCI state to indicate a common beam for more than one DL channel or RS. A type 3 TCI may be a separate UL common TCI state to indicate a common beam for more than one UL channel/RS. A type 4 TCI may be a separate DL single channel or RS TCI state to indicate a beam for a single DL channel or RS. A type 5 TCI may be a separate UL single channel or RS TCI state to indicate a beam for a single UL channel or RS. A type 6 TCI may include UL spatial relation information (e.g., such as sounding reference signal (SRS) resource indicator (SRI)) to indicate a beam for a single UL channel or RS. An example RS may be an SSB, a tracking reference signal (TRS) and associated CSI-RS for tracking, a CSI-RS for beam management, a CSI-RS for CQI management, a DM-RS associated with non-UE-dedicated reception on PDSCH and a subset (which may be a full set) of control resource sets (CORESETs), or the like. A TCI state may be defined to represent at least one source RS to provide a reference (e.g., UE assumption) for determining quasi-co-location (QCL) or spatial filters. For example, a TCI state may define a QCL assumption between a source RS and a target RS.

As another example, a spatial relation change, such as a spatial relation update, may trigger the UE to switch beams. Beamforming may be applied to uplink channels, such as but not limited to PUCCH. Beamforming may be based on configuring one or more spatial relations between the uplink and downlink signals. Spatial relation may indicate that a UE may transmit the uplink signal using the same beam as it used for receiving the corresponding downlink signal.

Different procedures for managing and controlling beam may be collectively referred to as “beam management.” The process of selecting a beam to switch to for data channels or control channels may be referred to as “beam selection.” In some wireless communication systems, beam selection for data channels or control channels may be performed for beams within a same physical cell identifier (ID) (PCI).

By way of example, a UE may encounter two types of mobility-cell-level mobility and beam-level mobility (which may be beam-based mobility). For cell-level mobility, a UE may experience an inter-base station handover. In some wireless communication systems, for beam-level mobility, as explained herein, switching of beams may occur within a same base station.

In some wireless communication systems, inter-cell beam management may be based on beam-based mobility where the indicated beam may be from a TRP with different PCI with regard to the serving cell. Benefits of inter-cell beam management based on beam-based mobility may include more robustness against blocking, more opportunities for higher rank for subscriber data management (SDM) across different cells, and in general more efficient communication between a UE and the network.

As an example, inter-cell beam management based on beam-based mobility may be facilitated by L1 and/or L2 (referred to as “L1/L2” herein) signaling such as UE-dedicated channels/RSs which may be associated with a switch to a TRP with different PCI according to downlink control information (DCI) or medium access control (MAC) control element (MAC-CE) based unified TCI update. As used herein, such mobility may be referred to as L1/L2 mobility. In some wireless communication systems PCell change using L1/L2 signaling is not supported. A UE may be in the coverage of the serving cell when communicating with TRP with different PCI (no support for a serving cell change).

In some aspects, the network may configure a set of cells for L1/L2 mobility. The set of cells for L1/L2 mobility may be referred to as “L1/L2 mobility configured cell set” or “mobility configured cell set.” The L1/L2 mobility configured cell set may include an “L1/L2 mobility activated cell set” (which may also be referred to as a “L1/L2 activated mobility cell set,” or “mobility activated cell set”) and an “L1/L2 mobility deactivated cell set” (which may also be referred to as a “deactivated L1/L2 mobility cell set,” or a “mobility deactivated cell set”). The L1/L2 mobility activated cell set may be a group of cells in the L1/L2 mobility configured cell set that are activated and may be readily used for data and control transfer. The L1/L2 mobility deactivated cell set (which may be a L1/L2 mobility candidate cell set) may be a group of cells in the configured set that are configured for the UE for L1/L2 mobility that may be activated by L1/L2 signaling. Once activated, a deactivated cell may be used for data and control transfer.

For mobility management of the activated cell set, L1/L2 signaling may be used to activate/deactivate cells in the L1/L2 mobility configured cell set and to select beams within the activated cells (of the activated cell set). As the UE moves, cells from the L1/L2 mobility configured cell set may be deactivated and activated by L1/L2 signaling based on signal quality (e.g., based on measurements), loading, or the like. Example measurements may include cell coverage measurements represented by reference signal received power (RSRP), and quality represented by reference signal received quality (RSRQ), or other measurements that the UE performs on signals from the base station. In some aspects, the measurements may be L1 measurements or L2 measurements such as one or more of an RSRP, an RSRQ, a received signal strength indicator (RSSI), or a signal to interference and noise ratio (SINR) measurement of various signals, such as a SSB, a PSS, an SSS, a broadcast channel (BCH), a DM-RS, CSI-RS, or the like.

In some aspects, all cells in the L1/L2 mobility configured cell set may belong to a same DU and the cells may be on a same or different carrier frequencies. Cells in the L1/L2 mobility configured cell set may cover a mobility area.

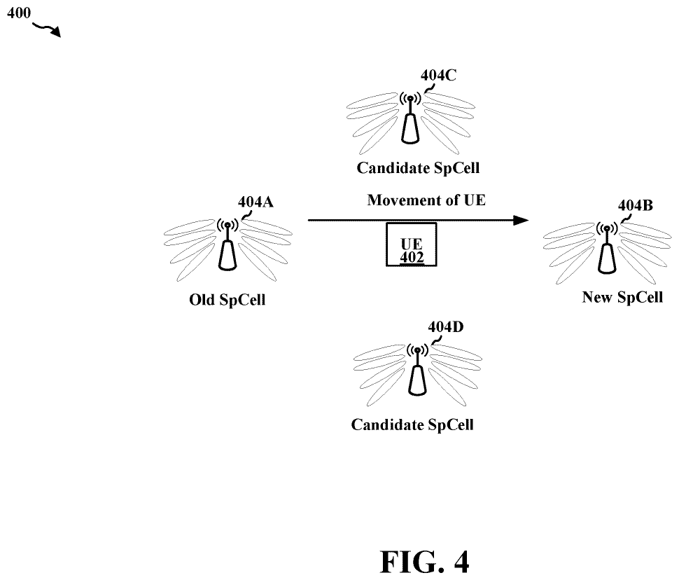

As a UE moves, a special cell (SpCell) may be reselected or updated among a set of configured candidate SpCells based on the UE's measurements (e.g., L1 measurements such as RSRP, RSRQ, RSSI, SINR, or the like) for the candidate cells. An SpCell may be a primary cell (PCell) or a primary secondary cell (PSCell). FIG. 4 is a diagram 400 illustrating an example of movement of UE and associated switching of SpCell based on a configured candidate SpCell set.

As illustrated in FIG. 4, as a UE 402 moves, the UE 402 may update the SpCell from old SpCell 404A to one of the candidate SpCells in the configured candidate SpCell set including candidate SpCell 404B, candidate SpCell 404C, and candidate SpCell 404D. The configured candidate SpCell set may be configured before the UE moves.

The candidate SpCells may be activated before being selected as a new SpCell or may be deactivated before being selected as a new SpCell. In some aspects, each of the candidate SpCell 404B, the candidate SpCell 404C, and the candidate SpCell 404D may be associated with a same frequency or different frequency. For example, the candidate SpCell 404B may be associated with a first frequency, the candidate SpCell 404C may be associated with a second frequency, and the candidate SpCell 404C may be associated a third frequency. For example, the other cells sharing the TAG 1 with the candidate SpCell 404B may include candidate SpCell and SCells in a candidate cell group associated with a physical cell site associated with the candidate SpCell 404B. In some aspects, the candidate SpCell and SCells in the candidate cell group associated with a physical cell site associated with the candidate SpCell 404B may not be activated until the candidate SpCell 404B is activated and selected as a new SpCell.

In some wireless communication systems, layer 3 (L3) intra-frequency measurements may be supported. An example L3 intra-frequency measurement may be based on measured neighbor cell SSB with a same center frequency and a same SCS as the measured SSB of the serving cell. A measurement may be an SSB-based intra-frequency measurement, provided that the center frequency of the SSB of the serving cell indicated for measurement and the center frequency of the SSB of the neighbor cell are the same, and the subcarrier spacing of the two SSBs are also the same. L3 measurements that do not satisfy the condition (measured neighbor cell SSB with a same center frequency and a same SCS as the measured SSB of the serving cell) may be referred to as inter-frequency measurement.

As used herein, the term “inter-frequency measurement” may refer to measuring RSs of different center frequency, different SCS, or a different bandwidth part. As used herein, the term “measurement information” may refer to results of the measurement, which may be RSRP, RSRQ, RSSI, SINR, or the like. As used herein, the term “inter-frequency RS reporting” may refer to the process of reporting inter-frequency measurement, such as measurement based on inter-frequency RS (e.g., SSB or CSI). As used herein, the term “L1 inter-frequency CSI report” may refer to a report, such as a report in a PUSCH, that reports L1 (physical layer) inter-frequency measurement such as L1 RSRP, L1 RSRQ, L1 RSSI, or L1 SINR, to the network. As one example, an L1 inter-frequency report may include a subset of the measurement information. For example, measurement information based on top N inter-frequency RSs across all the measured frequencies or across M UE-selected frequencies or top N inter-frequency RSs per each measured frequency or each of M UE-selected frequencies may be included in the L1 inter-frequency report. As used herein, the term “a configuration of inter-frequency RS reporting” may refer to a configuration indicative of RSs used for L1 inter-frequency RS reporting, such as one or more indexes.

In some wireless communication systems, L1 RSRP measurement may be performed for RS in active BWP, which may not use measurement gap. When configured by the network, the UE may be able to perform L1-RSRP measurements of configured CSI-RS, SSB, or CSI-RS and SSB resources for L1-RSRP. The measurement may be performed for a serving cell, including PCell, PSCell, or SCell, on the resources configured for L1-RSRP measurements within the active BWP.

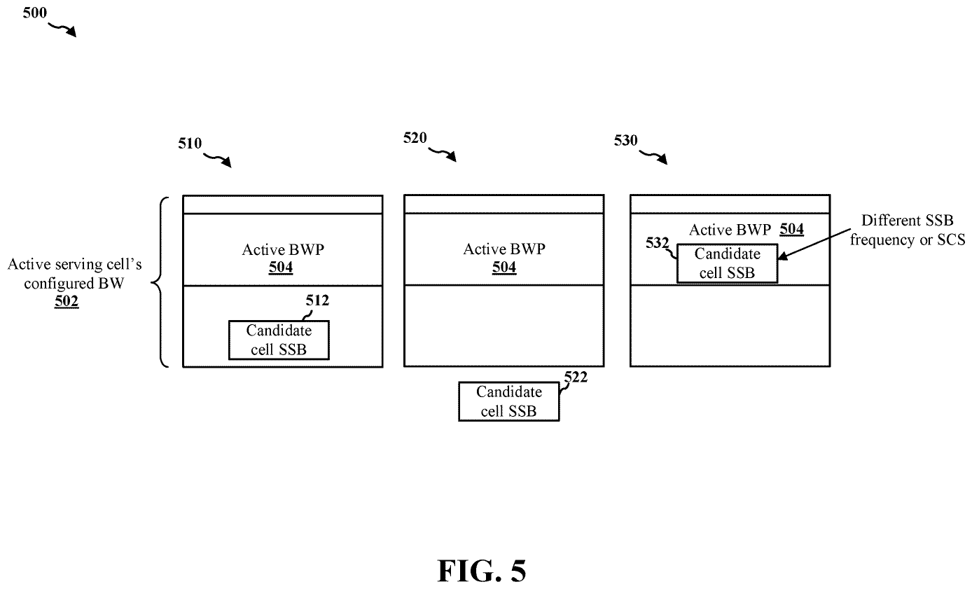

Aspects provided herein may provide L1 measurements where measurement gap may be used. Such L1 measurements may be used for L1/L2 mobility and may support both intra-frequency or inter-frequency measurements. FIG. 5 is a diagram 500 illustrating an example of L1 measurement. As illustrated in FIG. 5, in a first example 510, the measured candidate cell's SSB 512 is outside active BWP 504 and within configured BW 502 of activated serving cell. In a second example 520, the measured candidate cell's SSB 522 is outside configured BW 502 of activated serving cell. In a third example 530, measured candidate cell's SSB 532 is within active BWP 504 and associated with a center frequency or an SCS different from those of measured SSB of activated serving cell.

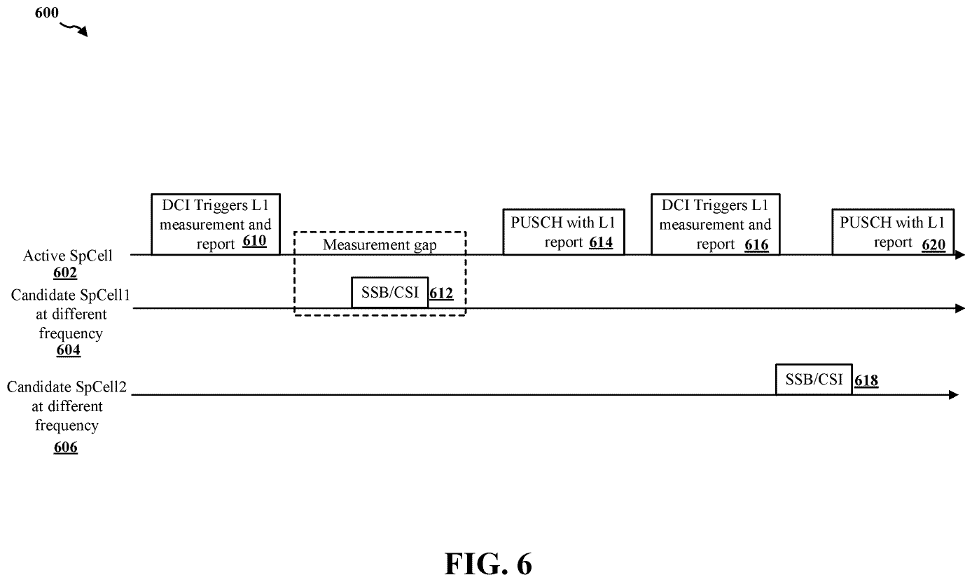

FIG. 6 is a diagram 600 illustrating an example of communications related to L1 inter-frequency CSI report. As illustrated in FIG. 6, a UE may receive a DCI 610 that triggers L1 measurement and report on an active SpCell 602. The UE may accordingly perform measurements on one or more RSs, such as SSB/CSI 612, on a first candidate SpCell 1 604 at a different frequency (compared with the active SpCell). After performing the measurements on the one or more RSs, the UE may then transmit a PUSCH with L1 report 614 to the network. The UE may receive a DCI 616 that triggers L1 measurement and report on an active SpCell 602. The UE may accordingly perform measurements on one or more RSs, such as SSB/CSI 618, on a second candidate SpCell 2 606 at a different frequency (compared with the active SpCell). After performing the measurements on the one or more RSs, the UE may then transmit a PUSCH with L1 report 620 to the network.

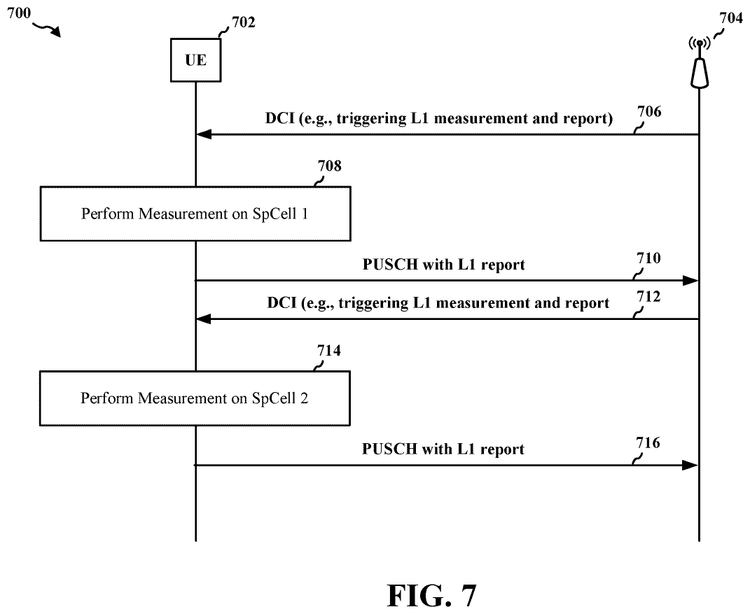

FIG. 7 is a diagram 700 illustrating example communications between a network entity 704 and a UE 702. In some aspects, the network entity 704 may be a network node. In some aspects, the network node may be implemented as an aggregated base station, a disaggregated base station, an integrated access and backhaul (IAB) node, a relay node, a sidelink node, or the like. In some aspects, the network entity 704 may be implemented in an aggregated or monolithic base station architecture, or alternatively, in a disaggregated base station architecture, and may include one or more of a CU, a DU, a RU, a Near-Real Time (Near-RT) RAN Intelligent Controller (RIC), or a Non-Real Time (Non-RT) RIC.

As illustrated in FIG. 7, the network entity 704 may transmit a DCI 706 that may trigger L1 measurement and report to the UE 702 (e.g., associated with a first candidate SpCell). In some aspects, the DCI 706 may be indicative of a configuration of inter-frequency RS reporting in a L1 inter-frequency CSI report associated with one or more RSs. In some aspects, when the UE 702 is configured to report inter-frequency RS such as SSB or CSI in a L1 inter-frequency CSI report, the UE 702 may be configured with (e.g., based on the configuration of inter-frequency RS reporting) a RS index per measured frequency or a global RS index across all measured frequencies. In some aspects, the UE 702 may be configured with multiple RS sets, and each set of RSs may have a different frequency. In some of such aspects, the UE 702 may be configured with a RS index per each respective frequency associated with each respective set of RSs. In some aspects, the UE 702 may be configured with a single RS set including RSs that have different frequencies. In some of such aspects, the UE 702 may be configured with a global RS index across all the different frequencies associated with the RSs in the single RS set.

In some aspects, the one or more RSs may be inter-frequency RSs such as SSB or CSI and may be associated with a candidate cell to be measured (which may also be referred to as “measured candidate cell) and may be one of: (1) measured candidate cell's SSB outside active BWP but within configured BW of activated serving cell, (2) measured candidate cell's SSB outside configured BW of activated serving cell, (3) The measured candidate cell's SSB within active BWP but with center frequency or SCS different from those of measured SSB of activated serving cell, or (4) measured candidate cell's SSB that has different center frequency or SCS from center frequency or SCS of SSB of any activated serving cell.

In some aspects, after receiving the DCI 706, the UE may perform measurements on a first candidate SpCell (SpCell 1) at 708. In some aspects, after receiving the DCI 706, the UE may perform measurements on a first candidate SpCell (SpCell 1) at 708 based on the one or more RSs to generate measurement information associated with the one or more RSs. In some aspects, after generating measurement information associated with the one or more RSs at 708, the UE 702 may transmit a PUSCH 710 with a L1 inter-frequency CSI report, the L1 inter-frequency CSI report may be based on the measurement information. In some aspects, the L1 inter-frequency CSI report may include a subset of the measurement information. In some aspects, measurement information based on top N (e.g., in terms of RSRP, RSRQ, RSSI, or SINR) inter-frequency RSs across all the measured frequencies may be included in the L1 inter-frequency CSI report in the PUSCH 710. In some aspects, measurement information based on top N (e.g., in terms of RSRP, RSRQ, RSSI, or SINR) inter-frequency RSs across M UE-selected frequencies may be included in the L1 inter-frequency CSI report in the PUSCH 710. In some aspects, measurement information based on top N (e.g., in terms of RSRP, RSRQ, RSSI, or SINR) inter-frequency RSs per each measured frequency may be included in the L1 inter-frequency CSI report in the PUSCH 710. In some aspects, measurement information based on top N (e.g., in terms of RSRP, RSRQ, RSSI, or SINR) inter-frequency RSs per each of M UE-selected frequencies may be included in the L1 inter-frequency CSI report in the PUSCH 710.

In some aspects, in the L1 inter-frequency CSI report in the PUSCH 710, one RS with a largest metric (e.g., largest RSRP, RSRQ, RSSI, or SINR) may be reported using an absolute value for the metric, and the remaining RSs may be each reported based on a relative value (compared with the absolute value). In some aspects, the L1 inter-frequency CSI report in the PUSCH 710 may also include information indicative of which RS set or frequency has the largest metric. In some aspects, in the L1 inter-frequency CSI report in the PUSCH 710, for each RS set or frequency, one RS with a largest metric (e.g., largest RSRP, RSRQ, RSSI, or SINR) may be reported using an absolute value for the metric, and the remaining RSs may be each reported based on a relative value (compared with the absolute value).

In some aspects, the network entity 704 may transmit a DCI 712 that may trigger L1 measurement and report to the UE 702. In some aspects, the DCI 712 may be indicative of a configuration of inter-frequency RS reporting in a L1 inter-frequency CSI report associated with one or more RSs (e.g., associated with a second candidate SpCell). In some aspects, when the UE 702 is configured to report inter-frequency RS such as SSB or CSI in a L1 inter-frequency CSI report, the UE 702 may be configured with (e.g., based on the configuration of inter-frequency RS reporting) a RS index per measured frequency or a global RS index across all measured frequencies. In some aspects, the UE 702 may be configured with multiple RS sets, and each set of RSs may have a different frequency. In some of such aspects, the UE 702 may be configured with a RS index per each respective frequency associated with each respective set of RSs. In some aspects, the UE 702 may be configured with a single RS set including RSs that have different frequencies. In some of such aspects, the UE 702 may be configured with a global RS index across all the different frequencies associated with the RSs in the single RS set.

In some aspects, the one or more RSs may be inter-frequency RSs such as SSB or CSI and may be associated with a candidate cell to be measured (which may also be referred to as “measured candidate cell) and may be one of: (1) measured candidate cell's SSB outside active BWP but within configured BW of activated serving cell, (2) measured candidate cell's SSB outside configured BW of activated serving cell, (3) The measured candidate cell's SSB within active BWP but with center frequency or SCS different from those of measured SSB of activated serving cell, or (4) measured candidate cell's SSB that has different center frequency or SCS from center frequency or SCS of SSB of any activated serving cell.

In some aspects, after receiving the DCI 712, the UE may perform measurements on a second candidate SpCell (SpCell 2) at 714. In some aspects, after receiving the DCI 712, the UE may perform measurements on a second candidate SpCell (SpCell 2) at 714 based on the one or more RSs to generate measurement information associated with the one or more RSs. In some aspects, after generating measurement information associated with the one or more RSs at 714, the UE 702 may transmit a PUSCH 716 with a L1 inter-frequency CSI report, the L1 inter-frequency CSI report may be based on the measurement information. In some aspects, the L1 inter-frequency CSI report may include a subset of the measurement information. In some aspects, measurement information based on top N (e.g., in terms of RSRP, RSRQ, RSSI, or SINR) inter-frequency RSs across all the measured frequencies may be included in the L1 inter-frequency CSI report in the PUSCH 716. In some aspects, measurement information based on top N (e.g., in terms of RSRP, RSRQ, RSSI, or SINR) inter-frequency RSs across M UE-selected frequencies may be included in the L1 inter-frequency CSI report in the PUSCH 716. In some aspects, measurement information based on top N (e.g., in terms of RSRP, RSRQ, RSSI, or SINR) inter-frequency RSs per each measured frequency may be included in the L1 inter-frequency CSI report in the PUSCH 716. In some aspects, measurement information based on top N (e.g., in terms of RSRP, RSRQ, RSSI, or SINR) inter-frequency RSs per each of M UE-selected frequencies may be included in the L1 inter-frequency CSI report in the PUSCH 716.

In some aspects, in the L1 inter-frequency CSI report in the PUSCH 716, one RS with a largest metric (e.g., largest RSRP, RSRQ, RSSI, or SINR) may be reported using an absolute value for the metric, and the remaining RSs may be each reported based on a relative value (compared with the absolute value). In some aspects, the L1 inter-frequency CSI report in the PUSCH 716 may also include information indicative of which RS set or frequency has the largest metric. In some aspects, in the L1 inter-frequency CSI report in the PUSCH 716, for each RS set or frequency, one RS with a largest metric (e.g., largest RSRP, RSRQ, RSSI, or SINR) may be reported using an absolute value for the metric, and the remaining RSs may be each reported based on a relative value (compared with the absolute value).

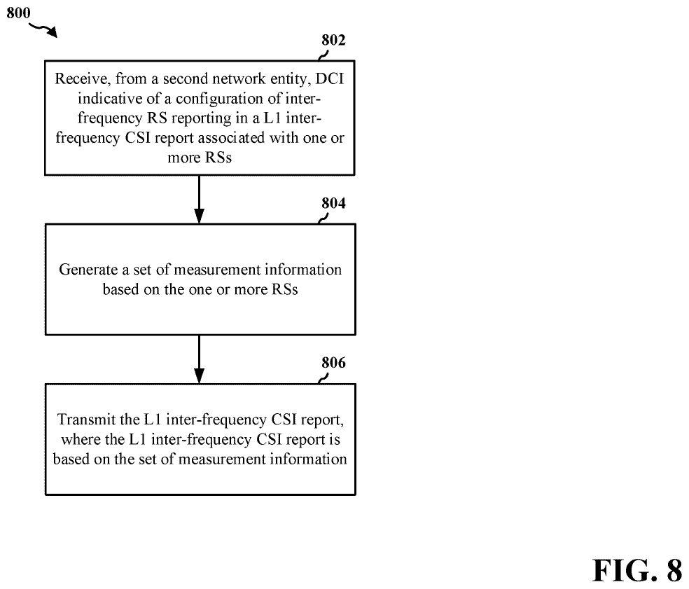

FIG. 8 is a flowchart 800 of a method of wireless communication. The method may be performed by a first network entity (e.g., the UE 104, the UE 702, the apparatus 1004).

At 802, the first network entity may receive, from a second network entity, DCI indicative of a configuration of inter-frequency RS reporting in a L1 inter-frequency CSI report associated with one or more RSs. For example, the UE 702 may receive, from a network entity 704, DCI (e.g., 706 or 712) indicative of a configuration of inter-frequency RS reporting in a L1 inter-frequency CSI report associated with one or more RSs. In some aspects, the DCI may be received on an active SpCell associated with a first frequency and the one or more RSs may be associated with a candidate cell (e.g., deactivated candidate SpCell) associated with a frequency different from the first frequency. In some aspects, the DCI may be received on an active cell associated with a first SCS and the one or more RSs may be associated with a candidate cell associated with a SCS different from the first SCS. In some aspects, 802 may be performed by CSI component 198. In some aspects, the one or more RSs include one or more SSBs. In some aspects, the one or more SSBs include an SSB associated with a candidate cell, where the SSB is outside of an active BWP and within a configured BW of an activated serving cell. In some aspects, the one or more SSBs include an SSB associated with a candidate cell, where the SSB is outside of a configured BW of an activated serving cell. In some aspects, the one or more SSBs include a first SSB associated with a candidate cell and a second SSB associated with an activated serving cell, where the first SSB is within an active BWP, where the first SSB is associated with a first center frequency or a first SCS and the second SSB is associated with a second center frequency or a second SCS, and where the first center frequency is different from the second center frequency and the first SCS is different from the second SCS. In some aspects, the one or more SSBs include a first SSB associated with a candidate cell, where the first network entity is associated with a second SSB associated with an activated serving cell, where the first SSB is within an active BWP, where the first SSB is associated with a first center frequency or a first SCS and the second SSB is associated with a second center frequency or a second SCS, and where the first center frequency is different from the second center frequency and the first SCS is different from the second SCS. In some aspects, the one or more RSs include one or more CSI RSs. In some aspects, the configuration includes a set of RS indexes, and where each RS index of the set of RS indexes corresponds to a respective frequency associated with the one or more RSs. In some aspects, the one or more RSs includes multiple sets of RSs, and where each set of RSs of the multiple sets of RSs is associated with a respective frequency. In some aspects, the configuration includes a global RS index associated with the one or more RSs. In some aspects, the one or more RSs includes one set of RSs, and where each RS of the one set of RSs is associated with a respective frequency.

At 804, the first network entity may generate measurement information based on the one or more RSs. For example, the UE 702 may generate (e.g., at 708 or 714) measurement information based on the one or more RSs. In some aspects, 804 may be performed by CSI component 198.

At 806, the first network entity may transmit the L1 inter-frequency CSI report, where the L1 inter-frequency CSI report is based on the measurement information. For example, the UE 702 may transmit the L1 inter-frequency CSI report (e.g., in 710 or 716), where the L1 inter-frequency CSI report is based on the measurement information. In some aspects, 806 may be performed by CSI component 198. In some aspects, the L1 inter-frequency CSI report includes a subset of measurement information in the measurement information, where the subset of measurement information includes first measurement information associated with a top N RSs in the one or more RSs across all frequencies associated with the one or more RSs, and where N is a positive integer. In some aspects, the UE 702 may indicate a UE capability to the network entity 704 about the maximum supported number of candidate cells and the maximum supported number of beams. For example, for L1 inter-frequency measurement report, the UE 702 may report measurement results for multiple candidate cells on multiple frequencies, and may report a number of X best candidate cells across all measured frequencies with a number of Y best beams per reported candidate cell in the same report, where the number of X and Y may be configured (e.g., by signaling such as RRC signaling) corresponding to UE capabilities of the UE 702 and may be positive integers. For another example, for L1 intra-frequency measurement report, the UE 702 may report a number of X best candidate cells with Y best beams per reported candidate cell, where the number of X and Y may be configured (e.g., by signaling such as RRC signaling) corresponding to UE capabilities of the UE 702. In some aspects, the L1 inter-frequency CSI report includes a subset of measurement information in the measurement information, where the subset of measurement information includes first measurement information associated with a top N RSs in the one or more RSs across M selected (e.g., selected by the UE 702) frequencies associated with the one or more RSs, and where Nis a positive integer and M is a positive integer. In some aspects, the L1 inter-frequency CSI report includes a subset of measurement information in the measurement information, where the subset of measurement information includes first measurement information associated with a top NRSs in the one or more RSs for each frequency associated with the one or more RSs, and where N is a positive integer. In some aspects, the L1 inter-frequency CSI report includes a subset of measurement information in the measurement information, where the subset of measurement information includes first measurement information associated with a top N RSs in the one or more RSs for each frequency of M selected (e.g., selected by the UE 702) frequencies associated with the one or more RSs, and where N is a positive integer and M is a positive integer. In some aspects, the measurement information includes a set of RSRPs, a set of SINRs, a set of RSRQs, or a set of RSSIs. In some aspects, the L1 inter-frequency CSI report includes an absolute value of RSRP, an absolute value of SINR, an absolute value of RSRQ, or an absolute value of RSSI associated with a first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs. In some aspects, the one or more RSs include multiple sets of RSs, where the L1 inter-frequency CSI report further includes information indicative of which RS set in the multiple sets of RSs is associated with a largest RSRP, a largest SINR, a largest RSRQ, or a largest RSSI. In some aspects, for each frequency associated with the one or more RSs, the L1 inter-frequency CSI report includes an absolute value of RSRP, an absolute value of SINR, an absolute value of RSRQ, or an absolute value of RSSI associated with a respective first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

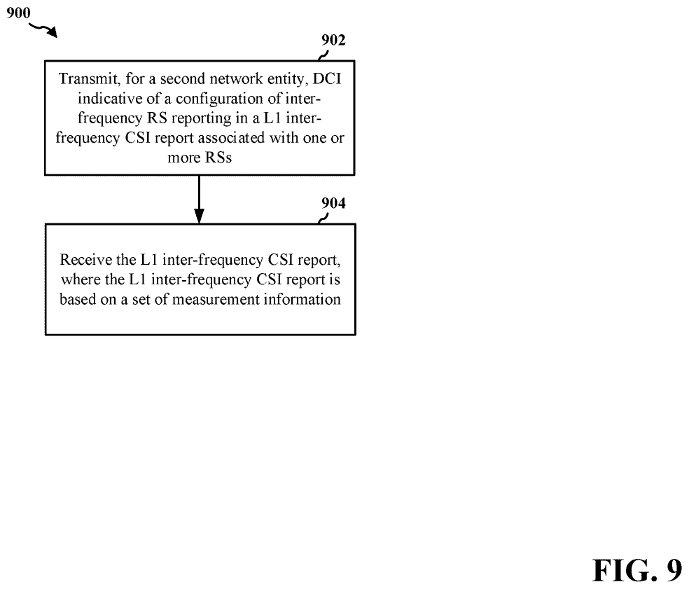

FIG. 9 is a flowchart 900 of a method of wireless communication. The method may be performed by a first network entity (e.g., the base station 102, the network entity 704, the network entity 1002, the network entity 1102).

At 902, the network entity may transmit, for a second network entity, DCI indicative of a configuration of inter-frequency RS reporting in a L1 inter-frequency CSI report associated with one or more RSs. For example, the network entity 704 may transmit, for a second network entity (e.g., the UE 702), DCI (e.g., 706 or 712) indicative of a configuration of inter-frequency RS reporting in a L1 inter-frequency CSI report associated with one or more RSs. In some aspects, the DCI may be transmitted on an active SpCell associated with a first frequency and the one or more RSs may be associated with a candidate SpCell associated with a frequency different from the first frequency. In some aspects, the DCI may be transmitted on an active SpCell associated with a first SCS and the one or more RSs may be associated with a candidate SpCell associated with a SCS different from the first SCS. In some aspects, 902 may be performed by CSI component 199. In some aspects, the one or more RSs include one or more SSBs. In some aspects, the one or more SSBs include an SSB associated with a candidate cell, where the SSB is outside of an active BWP and within a configured BW of an activated serving cell. In some aspects, the one or more SSBs include an SSB associated with a candidate cell, where the SSB is outside of a configured BW of an activated serving cell. In some aspects, the one or more SSBs include a first SSB associated with a candidate cell and a second SSB associated with an activated serving cell, where the first SSB is within an active BWP, where the first SSB is associated with a first center frequency or a first SCS and the second SSB is associated with a second center frequency or a second SCS, and where the first center frequency is different from the second center frequency and the first SCS is different from the second SCS. In some aspects, the one or more SSBs include a first SSB associated with a candidate cell, where the first network entity is associated with a second SSB associated with an activated serving cell, where the first SSB is within an active BWP, where the first SSB is associated with a first center frequency or a first SCS and the second SSB is associated with a second center frequency or a second SCS, and where the first center frequency is different from the second center frequency and the first SCS is different from the second SCS. In some aspects, the one or more RSs include one or more CSI RSs. In some aspects, the configuration includes a set of RS indexes, and where each RS index of the set of RS indexes corresponds to a respective frequency associated with the one or more RSs. In some aspects, the one or more RSs includes multiple sets of RSs, and where each set of RSs of the multiple sets of RSs is associated with a respective frequency. In some aspects, the configuration includes a global RS index associated with the one or more RSs. In some aspects, the one or more RSs includes one set of RSs, and where each RS of the one set of RSs is associated with a respective frequency.

At 904, the network entity may receive the L1 inter-frequency CSI report, where the L1 inter-frequency CSI report is based on measurement information. For example, the network entity 704 may receive the L1 inter-frequency CSI report (e.g., in 710 or 716), where the L1 inter-frequency CSI report is based on measurement information. In some aspects, 904 may be performed by CSI component 199. In some aspects, the L1 inter-frequency CSI report includes a subset of measurement information in the measurement information, where the subset of measurement information includes first measurement information associated with a top N RSs in the one or more RSs across all frequencies associated with the one or more RSs, and where N is a positive integer. In some aspects, the L1 inter-frequency CSI report includes a subset of measurement information in the measurement information, where the subset of measurement information includes first measurement information associated with a top N RSs in the one or more RSs across M selected (e.g., selected by the UE 702) frequencies associated with the one or more RSs, and where N is a positive integer and M is a positive integer. In some aspects, the L1 inter-frequency CSI report includes a subset of measurement information in the measurement information, where the subset of measurement information includes first measurement information associated with a top N RSs in the one or more RSs for each frequency associated with the one or more RSs, and where Nis a positive integer. In some aspects, the L1 inter-frequency CSI report includes a subset of measurement information in the measurement information, where the subset of measurement information includes first measurement information associated with a top N RSs in the one or more RSs for each frequency of M selected (e.g., selected by the UE 702) frequencies associated with the one or more RSs, and where N is a positive integer and Mis a positive integer. In some aspects, the measurement information includes a set of RSRPs, a set of SINRs, a set of RSRQs, or a set of RSSIs. In some aspects, the L1 inter-frequency CSI report includes an absolute value of RSRP, an absolute value of SINR, an absolute value of RSRQ, or an absolute value of RSSI associated with a first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs. In some aspects, the one or more RSs include multiple sets of RSs, where the L1 inter-frequency CSI report further includes information indicative of which RS set in the multiple sets of RSs is associated with a largest RSRP, a largest SINR, a largest RSRQ, or a largest RSSI. In some aspects, for each frequency associated with the one or more RSs, the L1 inter-frequency CSI report includes an absolute value of RSRP, an absolute value of SINR, an absolute value of RSRQ, or an absolute value of RSSI associated with a respective first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

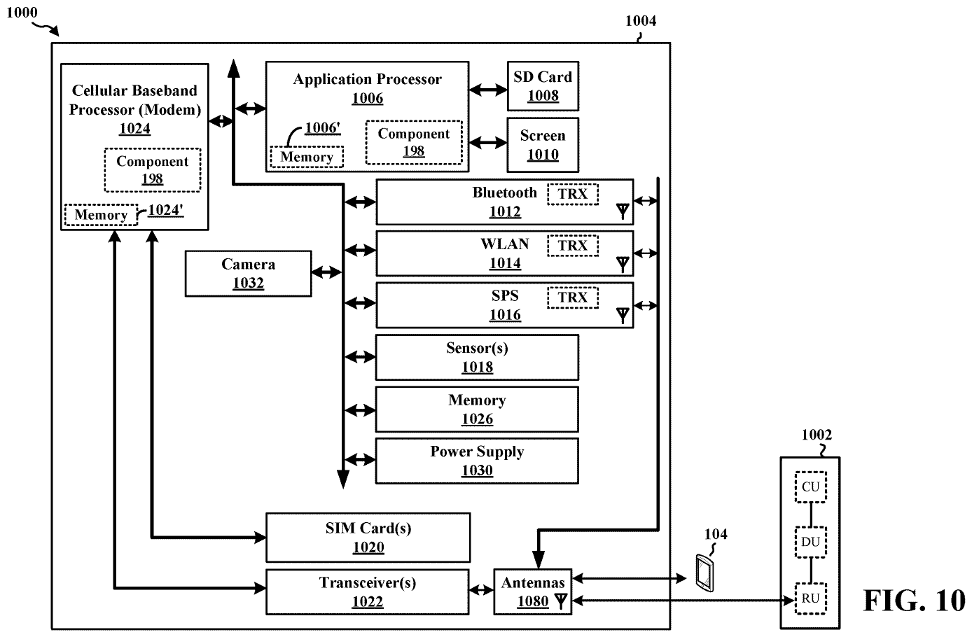

FIG. 10 is a diagram 1000 illustrating an example of a hardware implementation for an apparatus 1004. The apparatus 1004 may be a UE, a component of a UE, or may implement UE functionality. In some aspects, the apparatus1004 may include a cellular baseband processor 1024 (also referred to as a modem) coupled to one or more transceivers 1022 (e.g., cellular RF transceiver). The cellular baseband processor 1024 may include on-chip memory 1024′. In some aspects, the apparatus 1004 may further include one or more subscriber identity modules (SIM) cards 1020 and an application processor 1006 coupled to a secure digital (SD) card 1008 and a screen 1010. The application processor 1006 may include on-chip memory 1006′. In some aspects, the apparatus 1004 may further include a Bluetooth module 1012, a WLAN module 1014, a satellite system module 1016 (e.g., GNSS module), one or more sensor modules 1018 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the satellite system module 1016 may include an on-chip transceiver (TRX)/receiver (RX). The cellular baseband processor 1024 communicates through the transceiver(s) 1022 via one or more antennas 1080 with the UE 104 and/or with an RU associated with a network entity 1002. The cellular baseband processor 1024 and the application processor 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor 1024 and the application processor 1006 are each responsible for general processing, including the execution of software stored on the computer-readable medium/memory. The software, when executed by the cellular baseband processor 1024/application processor 1006, causes the cellular baseband processor 1024/application processor 1006 to perform the various functions described herein. The computer-readable medium/memory may also be used for storing data that is manipulated by the cellular baseband processor 1024/application processor 1006 when executing software. The cellular baseband processor 1024/application processor 1006 may be a component of the UE 350 and may include the memory 360 and/or at least one of the TX processor 368, the RX processor 356, and the controller/processor 359. In one configuration, the apparatus 1004 may be a processor chip (modem and/or application) and include just the cellular baseband processor 1024 and/or the application processor 1006, and in another configuration, the apparatus 1004 may be the entire UE (e.g., see 350 of FIG. 3) and include the additional modules of the apparatus 1004.

As discussed herein, the CSI component 198 may be configured to receive, from a second network entity, DCI indicative of a configuration of inter-frequency RS reporting in a L1 inter-frequency CSI report associated with one or more RSs. In some aspects, the CSI component 198 may be configured to generate measurement information based on the one or more RSs. In some aspects, the CSI component 198 may be configured to transmit the L1 inter-frequency CSI report, where the L1 inter-frequency CSI report is based on the measurement information. The CSI component 198 may be within the cellular baseband processor 1024, the application processor 1006, or both the cellular baseband processor 1024 and the application processor 1006. The CSI component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1004 may include a variety of components configured for various functions. In one configuration, the apparatus 1004, and in particular the cellular baseband processor 1024 and/or the application processor 1006, includes means for receiving, from a second network entity, DCI indicative of a configuration of inter-frequency RS reporting in a L1 inter-frequency CSI report associated with one or more RSs. In some aspects, the apparatus 1004 may further include means for generating measurement information based on the one or more RSs. In some aspects, the apparatus 1004 may further include means for transmitting the L1 inter-frequency CSI report, where the L1 inter-frequency CSI report is based on the measurement information. The means may be the CSI component 198 of the apparatus 1004 configured to perform the functions recited by the means. As described herein, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

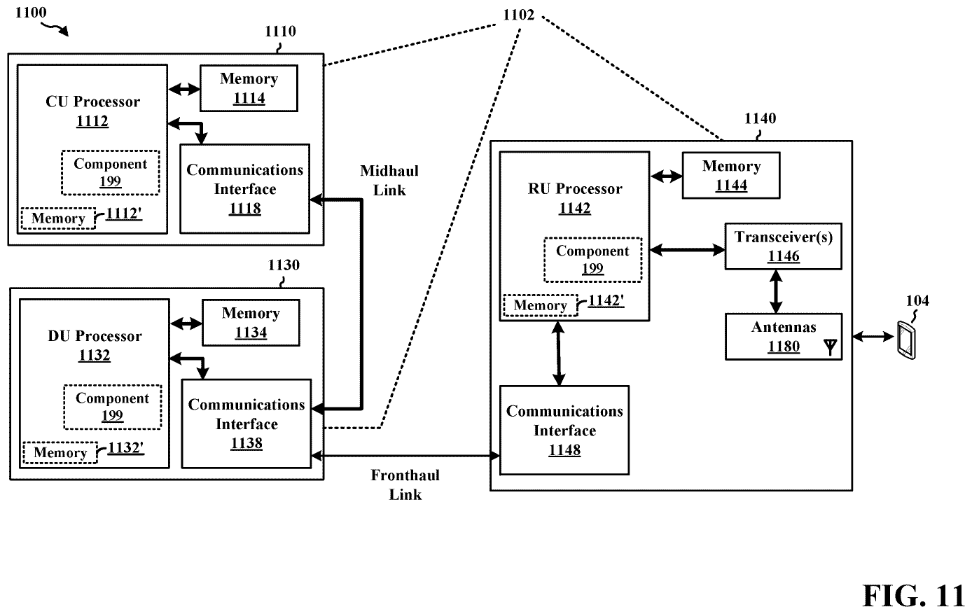

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include a CU processor 1112. The CU processor 1112 may include on-chip memory 1112′. In some aspects, the CU 1110 may further include additional memory modules 1114 and a communications interface 1118. The CU 1110 communicates with the DU 1130 through a midhaul link, such as an F1 interface. The DU 1130 may include a DU processor 1132. The DU processor 1132 may include on-chip memory 1132′. In some aspects, the DU 1130 may further include additional memory modules 1134 and a communications interface 1138. The DU 1130 communicates with the RU 1140 through a fronthaul link. The RU 1140 may include an RU processor 1142. The RU processor 1142 may include on-chip memory 1142′. In some aspects, the RU 1140 may further include additional memory modules 1144, one or more transceivers 1146, antennas 1180, and a communications interface 1148. The RU 1140 communicates with the UE 104. The on-chip memory 1112′, 1132′, 1142′ and the additional memory modules 1114, 1134, 1144 may each be considered a computer-readable medium/memory. Each computer-readable medium/memory may be non-transitory. Each of the processors 1112, 1132, 1142 is responsible for general processing, including the execution of software stored on the computer-readable medium/memory. The software, when executed by the corresponding processor(s) causes the processor(s) to perform the various functions described herein. The computer-readable medium/memory may also be used for storing data that is manipulated by the processor(s) when executing software.

As discussed herein, the CSI component 199 may be configured to transmit, for a second network entity, DCI indicative of a configuration of inter-frequency RS reporting in a L1 inter-frequency CSI report associated with one or more RSs. In some aspects, the CSI component 199 may be configured to receive the L1 inter-frequency CSI report, where the L1 inter-frequency CSI report is based on measurement information. The CSI component 199 may be within one or more processors of one or more of the CU 1110, DU 1130, and the RU 1140. The CSI component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1102 may include a variety of components configured for various functions. In one configuration, the network entity 1102 includes means for transmitting, for a second network entity, DCI indicative of a configuration of inter-frequency RS reporting in a L1 inter-frequency CSI report associated with one or more RSs. In some aspects, the network entity 1102 may further include means for receiving the L1 inter-frequency CSI report, where the L1 inter-frequency CSI report is based on measurement information. The means may be the CSI component 199 of the network entity 1102 configured to perform the functions recited by the means. As described herein, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a first network entity for wireless communication, including: a memory; and at least one processor coupled to the memory, where the at least one processor is configured to: receive, from a second network entity, downlink control information (DCI) indicative of a configuration of inter-frequency reference signal (RS) reporting in a layer 1 (L1) inter-frequency channel state information (CSI) report associated with one or more RSs; generate measurement information based on the one or more RSs; and transmit the L1 inter-frequency CSI report, where the L1 inter-frequency CSI report is based on the measurement information.

Aspect 2 is the first network entity of aspect 1, where the one or more RSs include one or more synchronization signal blocks (SSBs).

Aspect 3 is the first network entity of aspect 2, where the one or more SSBs include an SSB associated with a candidate cell, where the SSB is outside of an active bandwidth part (BWP) and within a configured bandwidth (BW) of an activated serving cell.

Aspect 4 is the first network entity of aspect 2, where the one or more SSBs include an SSB associated with a candidate cell, where the SSB is outside of a configured bandwidth (BW) of an activated serving cell.

Aspect 5 is the first network entity of aspect 2, where the one or more SSBs include a first SSB associated with a candidate cell and a second SSB associated with an activated serving cell, where the first SSB is within an active bandwidth part (BWP), where the first SSB is associated with a first center frequency or a first subcarrier spacing (SCS) and the second SSB is associated with a second center frequency or a second SCS, and where the first center frequency is different from the second center frequency and the first SCS is different from the second SCS.

Aspect 6 is the first network entity of aspect 2, where the one or more SSBs include a first SSB associated with a candidate cell, where the first network entity is associated with a second SSB associated with an activated serving cell, where the first SSB is within an active bandwidth part (BWP), where the first SSB is associated with a first center frequency or a first subcarrier spacing (SCS) and the second SSB is associated with a second center frequency or a second SCS, and where the first center frequency is different from the second center frequency and the first SCS is different from the second SCS.

Aspect 7 is the first network entity of aspect 1, where the one or more RSs include one or more CSI RSs.

Aspect 8 is the first network entity of any of aspects 1-7, where the configuration includes a set of RS indexes, and where each RS index of the set of RS indexes corresponds to a respective frequency associated with the one or more RSs.

Aspect 9 is the first network entity of aspect 8, where the one or more RSs includes multiple sets of RSs, and where each set of RSs of the multiple sets of RSs is associated with a respective frequency.

Aspect 10 is the first network entity of any of aspects 1-7, where the configuration includes a global RS index associated with the one or more RSs.

Aspect 11 is the first network entity of aspect 10, where the one or more RSs includes one set of RSs, and where each RS of the one set of RSs is associated with a respective frequency.

Aspect 12 is the first network entity of any of aspects 1-11, where the L1 inter-frequency CSI report includes a subset of measurement information in the measurement information, where the subset of measurement information includes first measurement information associated with a top N RSs in the one or more RSs across all frequencies associated with the one or more RSs, and where N is a positive integer.

Aspect 13 is the first network entity of aspect 1, where the L1 inter-frequency CSI report includes a subset of measurement information in the measurement information, where the subset of measurement information includes first measurement information associated with a top NRSs in the one or more RSs across M selected frequencies associated with the one or more RSs, and where N is a positive integer and M is a positive integer.

Aspect 14 is the first network entity of aspect 1, where the L1 inter-frequency CSI report includes a subset of measurement information in the measurement information, where the subset of measurement information includes first measurement information associated with a top N RSs in the one or more RSs for each frequency associated with the one or more RSs, and where N is a positive integer.

Aspect 15 is the first network entity of aspect 1, where the L1 inter-frequency CSI report includes a subset of measurement information in the measurement information, where the subset of measurement information includes first measurement information associated with a top NRSs in the one or more RSs for each frequency of M selected frequencies associated with the one or more RSs, and where N is a positive integer and M is a positive integer.

Aspect 16 is the first network entity of any of aspects 1-15, where the measurement information includes a set of reference signal received powers (RSRPs), a set of signal to interference and noise ratios (SINRs), a set of reference signal received qualities (RSRQs), or a set of received signal strength indicators (RSSIs).

Aspect 17 is the first network entity of aspect 16, where the L1 inter-frequency CSI report includes an absolute value of RSRP, an absolute value of SINR, an absolute value of RSRQ, or an absolute value of RSSI associated with a first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

Aspect 18 is the first network entity of aspect 17, where the one or more RSs include multiple sets of RSs, where the L1 inter-frequency CSI report further includes information indicative of which RS set in the multiple sets of RSs is associated with a largest RSRP, a largest SINR, a largest RSRQ, or a largest RSSI.

Aspect 19 is the first network entity of aspect 16, where, for each frequency associated with the one or more RSs, the L1 inter-frequency CSI report includes an absolute value of RSRP, an absolute value of SINR, an absolute value of RSRQ, or an absolute value of RSSI associated with a respective first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

Aspect 20 is a first network entity for wireless communication, including: a memory; and at least one processor coupled to the memory, where the at least one processor is configured to: transmit, for a second network entity, downlink control information (DCI) indicative of a configuration of inter-frequency reference signal (RS) reporting in a layer 1 (L1) inter-frequency channel state information (CSI) report associated with one or more RSs; and receive the L1 inter-frequency CSI report, where the L1 inter-frequency CSI report is based on measurement information.

Aspect 21 is the first network entity of aspect 20, where the one or more RSs include one or more synchronization signal blocks (SSBs).

Aspect 22 is the first network entity of aspect21, where the one or more SSBs include an SSB associated with a candidate cell, where the SSB is outside of an active bandwidth part (BWP) and within a configured bandwidth (BW) of an activated serving cell.

Aspect 23 is the first network entity of aspect21, where the one or more SSBs include an SSB associated with a candidate cell, where the SSB is outside of a configured bandwidth (BW) of an activated serving cell.

Aspect 24 is the first network entity of aspect 21, where the one or more SSBs include a first SSB associated with a candidate cell and a second SSB associated with an activated serving cell, where the first SSB is within an active bandwidth part (BWP), where the first SSB is associated with a first center frequency or a first subcarrier spacing (SCS) and the second SSB is associated with a second center frequency or a second SCS, and where the first center frequency is different from the second center frequency and the first SCS is different from the second SCS.

Aspect 25 is the first network entity of aspect21, where the one or more SSBs include a first SSB associated with a candidate cell, where the first network entity is associated with a second SSB associated with an activated serving cell, where the first SSB is within an active bandwidth part (BWP), where the first SSB is associated with a first center frequency or a first subcarrier spacing (SCS) and the second SSB is associated with a second center frequency or a second SCS, and where the first center frequency is different from the second center frequency and the first SCS is different from the second SCS.

Aspect 26 is the first network entity of aspect 21, where the one or more RSs include one or more CSI RSs.

Aspect 27 is the first network entity of any of aspects 20-26, where the configuration includes a set of RS indexes, and where each RS index of the set of RS indexes corresponds to a respective frequency associated with the one or more RSs.

Aspect 28 is the first network entity of aspect 27, where the one or more RSs includes multiple sets of RSs, and where each set of RSs of the multiple sets of RSs is associated with a respective frequency.

Aspect 29 is the first network entity of any of aspects 20-26, where the configuration includes a global RS index associated with the one or more RSs.

Aspect 30 is the first network entity of aspect 29, where the one or more RSs includes one set of RSs, and where each RS of the one set of RSs is associated with a respective frequency.

Aspect 31 is the first network entity of any of aspects 20-30, where the L1 inter-frequency CSI report includes a subset of measurement information in the measurement information, where the subset of measurement information includes first measurement information associated with a top N RSs in the one or more RSs across all frequencies associated with the one or more RSs, and where N is a positive integer.

Aspect 32 is the first network entity of aspect 20, where the L1 inter-frequency CSI report includes a subset of measurement information in the measurement information, where the subset of measurement information includes first measurement information associated with a top N RSs in the one or more RSs across M selected frequencies associated with the one or more RSs, and where N is a positive integer and M is a positive integer.

Aspect 33 is the first network entity of aspect 20, where the L1 inter-frequency CSI report includes a subset of measurement information in the measurement information, where the subset of measurement information includes first measurement information associated with a top N RSs in the one or more RSs for each frequency associated with the one or more RSs, and where N is a positive integer.

Aspect 34 is the first network entity of aspect 20, where the L1 inter-frequency CSI report includes a subset of measurement information in the measurement information, where the subset of measurement information includes first measurement information associated with a top NRSs in the one or more RSs for each frequency of M selected frequencies associated with the one or more RSs, and where N is a positive integer and M is a positive integer.

Aspect 35 is the first network entity of any of aspects 20-34, where the measurement information includes a set of reference signal received powers (RSRPs), a set of signal to interference and noise ratios (SINRs), a set of reference signal received qualities (RSRQs), or a set of received signal strength indicators (RSSIs).

Aspect 36 is the first network entity of aspect 35, where the L1 inter-frequency CSI report includes an absolute value of RSRP, an absolute value of SINR, an absolute value of RSRQ, or an absolute value of RSSI associated with a first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

Aspect 37 is the first network entity of aspect 36, where the one or more RSs include multiple sets of RSs, where the L1 inter-frequency CSI report further includes information indicative of which RS set in the multiple sets of RSs is associated with a largest RSRP, a largest SINR, a largest RSRQ, or a largest RSSI.

Aspect 38 is the first network entity of aspect35, where, for each frequency associated with the one or more RSs, the L1 inter-frequency CSI report includes an absolute value of RSRP, an absolute value of SINR, an absolute value of RSRQ, or an absolute value of RSSI associated with a respective first RS in the one or more RSs and one or more relative values that are relative to the absolute value of RSRP, the absolute value of SINR, the absolute value of RSRQ, or the absolute value of RSSI, where the one or more relative values are associated with one or more remaining RSs that are not the first RS in the one or more RSs.

Aspect 39 is a method of wireless communication for implementing any of aspects 20 to 38.

Aspect 40 is an apparatus for wireless communication including means for implementing any of aspects 20 to 38.

Aspect 41 is a computer-readable medium (e.g., a non-transitory computer-readable medium) storing computer executable code, where the code when executed by a processor causes the processor to implement any of aspects 20 to 38.

Aspect 42 is a method of wireless communication for implementing any of aspects 1 to 19.

Aspect 43 is an apparatus for wireless communication including means for implementing any of aspects 1 to 19.

Aspect 44 is a computer-readable medium (e.g., a non-transitory computer-readable medium) storing computer executable code, where the code when executed by a processor causes the processor to implement any of aspects 1 to 19.

1. A first network entity for wireless communication, comprising:
a memory; and
at least one processor coupled to the memory, wherein the at least one processor is configured to:
receive, from a second network entity, downlink control information (DCI) indicative of a configuration of inter-frequency reference signal (RS) reporting in a layer 1 (L1) inter-frequency channel state information (CSI) report associated with one or more RSs;
generate measurement information based on the one or more RSs; and
transmit the L1 inter-frequency CSI report, wherein the L1 inter-frequency CSI report is based on the measurement information.

2. The first network entity of claim 1, wherein the one or more RSs comprise one or more synchronization signal blocks (SSBs).

3. The first network entity of claim 2, wherein the one or more SSBs comprise an SSB associated with a candidate cell, wherein the SSB is outside of an active bandwidth part (BWP) and within a configured bandwidth (BW) of an activated serving cell.

4. The first network entity of claim 2, wherein the one or more SSBs comprise an SSB associated with a candidate cell, wherein the SSB is outside of a configured bandwidth (BW) of an activated serving cell.

5. The first network entity of claim 2, wherein the one or more SSBs comprise a first SSB associated with a candidate cell and a second SSB associated with an activated serving cell, wherein the first SSB is within an active bandwidth part (BWP), wherein the first SSB is associated with a first center frequency or a first subcarrier spacing (SCS) and the second SSB is associated with a second center frequency or a second SCS, and wherein the first center frequency is different from the second center frequency and the first SCS is different from the second SCS.

6. The first network entity of claim 2, wherein the one or more SSBs comprise a first SSB associated with a candidate cell, wherein the first net ork entity is associated with a second SSB associated with an activated serving cell, wherein the first SSB is within an active bandwidth part (BWP), wherein the first SSB is associated with a first center frequency or a first subcarrier spacing (SCS) and the second SSB is associated with a second center frequency or a second SCS, and wherein the first center frequency is different from the second center frequency and the first SCS is different from the second SCS.

7. The first network entity of claim 1, wherein the one or more RSs comprise one or more CSI RSs.

8. The first net ork entity of claim 1, wherein the configuration comprises a set of RS indexes, and wherein each RS index of the set of RS indexes corresponds to a respective frequency associated with the one or more RSs.

9. The first network entity of claim 8, wherein the one or more RSs comprises multiple sets of RSs, and wherein each set of RSs of the multiple sets of RSs is associated with a respective frequency.

10. The first network entity of claim 1, wherein the configuration comprises a global RS index associated with the one or more RSs.

11. The first network entity of claim 10, wherein the one or more RSs comprises one set of RSs, and wherein each RS of the one set of RSs is associated with a respective frequency.

12. The first network entity of claim 1, wherein the L1 inter-frequency CSI report comprises a subset of measurement information in the measurement information, wherein the subset of measurement information comprises first measurement information associated with a top N RSs in the one or more RSs across all frequencies associated with the one or more RSs, and wherein N is a positive integer.

13. The first network entity of claim 1, wherein the L1 inter-frequency CSI report comprises a subset of measurement information in the measurement information, wherein the subset of measurement information comprises first measurement information associated with a top N RSs in the one or more RSs across M selected frequencies associated with the one or more RSs and wherein N is a positive integer and M is a positive integer.

14. The first network entity of claim 1, wherein the L1 inter-frequency CSI report comprises a subset of measurement information in the measurement information, wherein the subset of measurement information comprises first measurement information associated with a top N RSs in the one or more RSs for each frequency associated with the one or more RSs, and wherein N is a positive integer.

15. The first network entity of claim 1, wherein the L1 inter-frequency CSI report comprises a subset of measurement information in the measurement information, wherein the subset of measurement information comprises first measurement information associated with a top N RSs in the one or more RSs for each frequency of M selected frequencies associated with the one or more RSs, and wherein N is a positive integer and M is a positive integer.

16. The first network entity of claim 1, wherein the measurement information comprises a set of reference signal received powers (RSRPs), a set of signal to interference and noise ratios (SINRs), a set of reference signal received qualities (RSRQs), or a set of received signal strength indicators (RSSIs).

17. The first network entity of claim 16, wherein the L1 inter-frequency CSI report comprises an absolute value of RSRP, an absolute value of SINR, an absolute value of RSRQ, or an absolute value of RSSI associated with a first RS in the one or more RSs and one or more relative values that are relative to the absolute value of RSRP, the absolute value of SINR, the absolute value of RSRQ, or the absolute value of RSSI, wherein the one or more relative values are associated with one or more remaining RSs that are not the first RS in the one or more RSs.

18. The first net ork entity of claim 17, wherein the one or more RSs comprise multiple sets of RSs, wherein the L1 inter-frequency CSI report further comprises information indicative of which RS set in the multiple sets of RSs is associated with a lar est RSRP, a largest SINR, a lar est RSRQ, or a largest RSSI.

19. The first network entity of claim 16, wherein, for each frequency associated with the one or more RSs, the L1 inter-frequency CSI report comprises an absolute value of RSRP, an absolute value of SINR, an absolute value of RSRQ, or an absolute value of RSSI associated with a respective first RS in the one or more RSs and one or more relative values that are relative to the absolute value of RSRP, the absolute value of SINR, the absolute value of RSRQ, or the absolute value of RSSI, wherein the one or more relative values are associated with one or more remaining RSs that are not the first RS in the one or more RSs.

20. A first network entity for wireless communication, comprising:
a memory; and
at least one processor coupled to the memory, wherein the at least one processor is configured to:
transmit, for a second network entity, downlink control information (DCI) indicative of a configuration of inter-frequency reference signal (RS) reporting in a layer 1 (L1) inter-frequency channel state information (CSI) report associated with one or more RSs; and
receive the L1 inter-frequency CSI report, wherein the L1 inter-frequency CSI report is based on measurement information.

21-30. (canceled)
